(19) United States
(12) Patent Application Publication
(10) Pub. No.: US 2023/0111194 A1
(43) Pub. Date: Apr. 13, 2023

(54) SDL Verification Tool

(71) Applicant: Dell Products L.P., Round Rock, TX (US)

(72) Inventors: Tomer Shachar, Omer (IL); Yevgeni Gehtman, Modi'in (IL); Maxim Balin, Gan-Yavne (IL)

(73) Assignee: Dell Products L.P., Round Rock, TX (US)

(21) Appl. No.: 17/496,860

(22) Filed: Oct. 8, 2021

(51) Int. Cl. G06F 8/71; G06F 21/62

(52) U.S. Cl. CPC G06F 8/71; G06F 21/629

(57) ABSTRACT

Methods, system, and non-transitory processor-readable storage medium for a secure development lifecycle compliance system are provided herein. An example method includes verifying secure development lifecycle (SDL) compliance by executing an SDL system in communication with an application development pipeline. The SDL system comprises a user interface, an application development pipeline interface, and at least one SDL verification module. The method verifies successful execution of the SDL system prior to advancing from a previous stage to a subsequent stage within the application development pipeline.

### FIELD

The field relates generally to Secure Development Lifecycle, and more particularly to Secure Development Lifecycle compliance in information processing systems.

### BACKGROUND

Secure development lifecycle's (SDL) compliance is often an obligatory process for a company's products or applications. The SDL process requires a very high level of understanding in various security fields and pillars, as well as in development processes.

### SUMMARY

Illustrative embodiments provide techniques for implementing a secure development lifecycle system in a storage system. For example, illustrative embodiments verify secure development lifecycle (SDL) compliance by executing an SDL system in communication with an application development pipeline. The SDL system comprises a user interface, an application development pipeline interface, and at least one SDL verification module. Illustrative embodiments verify successful execution of the SDL system prior to advancing from a previous stage to a subsequent stage within the application development pipeline. Other types of processing devices can be used in other embodiments.

These and other illustrative embodiments include, without limitation, apparatus, systems, methods and processor-readable storage media.

### BRIEF DESCRIPTION OF THE DRAWINGS

FIG. 1 shows an information processing system including a secure development lifecycle system in an illustrative embodiment.

FIG. 2 shows an example of a secure development lifecycle system in an illustrative embodiment.

FIG. 3 shows an example of a secure development lifecycle verification module in an illustrative embodiment.

FIG. 4 shows a flow diagram of a process for a secure development lifecycle system in an illustrative embodiment.

FIGS. 5 and 6 show examples of processing platforms that may be utilized to implement at least a portion of a secure development lifecycle system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a secure development lifecycle system, which technique may be used to provide, among other things, verification of secure development lifecycle (SDL) compliance by executing an SDL system in communication with an application development pipeline. The SDL system comprises a user interface, an application development pipeline interface, and at least one SDL verification module. Illustrative embodiments verify successful execution of the SDL system prior to advancing from a previous stage to a subsequent stage within the application development pipeline.

As security attacks including supply chain attacks become more and more frequent, the requirement to maintain secure development lifecycle compliance increases. In many companies, compliance with secure development lifecycle is mandatory for any product and/or application. The secure development lifecycle process requires an understanding of the software development process and a very high level of understanding in various security fields, as well as an understanding of the pillars of software security.

Conventional approaches to maintaining secure development lifecycle compliance can be problematic. There may be different teams of people with varying levels of a thorough understanding of secure development lifecycle compliance, who are chartered with implementing the secure development lifecycle policies and procedures that may be defined by, for example, a security officer of a company. To accurately implement secure development lifecycle compliance, teams must have a thorough understanding of the often complicated policies and procedures.

Conventional technologies do not have a process and system to implement and verify secure development lifecycle compliance. Conventional technologies do not have a system that continuously verifies that secure development lifecycle compliance is being performed. Conventional technologies do not provide a system that can define, and verify secure development lifecycle compliance for different applications and products. Conventional technologies do not provide a system that is scalable and can verify hierarchies of dependencies among the policies and procedures. Conventional technologies do not provide a system that provides the capability to expand verification of secure development lifecycle compliance through the use of secure development lifecycle verification modules. Conventional technologies do not provide a way for collaboration among the security officer/champion, product security champion, architect, quality assurance and development & deployment teams to insure secure development lifecycle compliance.

By contrast, in at least some implementations in accordance with the current technique as described herein, secure development lifecycle (SDL) compliance is verified by executing an SDL system in communication with an application development pipeline. The SDL system comprises a user interface, an application development pipeline interface, and at least one SDL verification module. Illustrative embodiments verify successful execution of the SDL system prior to advancing from a previous stage to a subsequent stage within the application development pipeline.

Thus, a goal of the current technique is to provide a method and a system for providing a secure development lifecycle system that can verify security policies across multiple and various applications and products. Another goal is to ensure that security requirement policies are maintained within secure development lifecycle minimum compliance levels, if not higher. Yet another goal is to provide a secure development lifecycle system that is scalable depending on the product/application and associated security requirement policies, including interdependencies among the policies. Yet another goal is a secure development lifecycle system that is triggered as part of the software development lifecycle, for example, in the build, packaging, etc.

In at least some implementations in accordance with the current technique described herein, the use of a secure development lifecycle system can provide one or more of the following advantages: continuously verifying compliance of secure development lifecycle across many and various applications and products assuring that minimum compliance levels are maintained, providing a system that is easily scaled and allows for verification of hierarchies of dependencies among the policies and procedures according to the requirement for secure development lifecycle compliance, and providing a system for collaboration among the security officer/champion, product security champion, architect, quality assurance and development & deployment teams to insure secure development lifecycle compliance.

In contrast to conventional technologies, in at least some implementations in accordance with the current technique as described herein, secure development lifecycle (SDL) compliance is verified by executing an SDL system in communication with an application development pipeline. The SDL system comprises a user interface, an application development pipeline interface, and at least one SDL verification module. Illustrative embodiments verify successful execution of the SDL system prior to advancing from a previous stage to a subsequent stage within the application development pipeline.

In an example embodiment of the current technique, at least one SDL verification module comprises verification requirements, verification logic, and at least one verification interface, where the verification logic is executed via the verification interface.

In an example embodiment of the current technique, at least one verification interface is in communication with at least one development tool.

In an example embodiment of the current technique, at least one verification interface is in communication with at least one database.

In an example embodiment of the current technique, at least one verification interface is in communication with at least one software repository.

In an example embodiment of the current technique, the secure development lifecycle system monitors successful execution of at least one SDL verification module in the SDL system.

In an example embodiment of the current technique, the secure development lifecycle system verifies successful completion of at least one SDL verification module.

In an example embodiment of the current technique, the secure development lifecycle system notifies the SDL system of failure of at least one SDL verification module.

In an example embodiment of the current technique, the secure development lifecycle system identifies an error that caused a failure of at least one SDL verification module.

In an example embodiment of the current technique, completion of at least one stage in the application development pipeline triggers execution of the SDL system.

In an example embodiment of the current technique, at least one verification interface is in communication with at least one second SDL verification module.

In an example embodiment of the current technique, successful execution of at least one second SDL verification module is a verification requirement of at least one SDL verification module.

In an example embodiment of the current technique, the previous stage is a testing stage of the application development pipeline, and the subsequent stage is a staging stage of the application development pipeline.

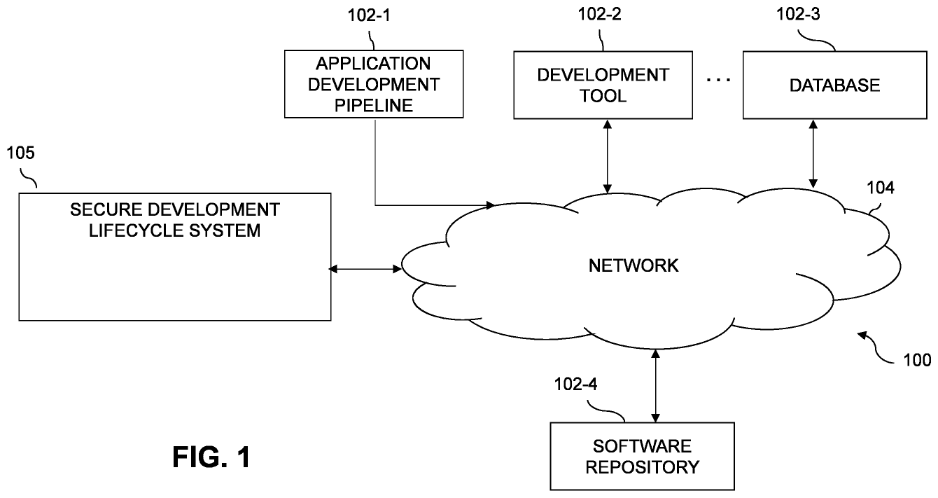

FIG. 1 shows a computer network (also referred to herein as an information processing system) 100 configured in accordance with an illustrative embodiment. The computer network 100 comprises an application development pipeline 102-1, a development tool 102-2, a database 102-3 and a software repository 102-4. The application development pipeline 102-1, development tool 102-2, database 102-3 and a software repository 102-4 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a secure development lifecycle system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the application development pipeline 102-1, development tool 102-2, database 102-3, and a software repository 102-4 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The application development pipeline 102-1, development tool 102-2, database 102-3, and a software repository 102-4 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the secure development lifecycle system 105 are one or more input-output devices, which illustratively comprise keyboards, displays or other types of input-output devices in any combination. Such input-output devices can be used, for example, to support one or more user interfaces to the secure development lifecycle system 105, as well as to support communication between the secure development lifecycle system 105 and other related systems and devices not explicitly shown. One or more input-output devices may also be associated with any of the application development pipeline 102-1, development tool 102-2, database 102-3 and a software repository 102-4.

Additionally, the secure development lifecycle system 105 in the FIG. 1 embodiment is assumed to be implemented using at least one processing device. Each such processing device generally comprises at least one processor and an associated memory, and implements one or more functional modules for controlling certain features of the secure development lifecycle system 105.

More particularly, the secure development lifecycle system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the secure development lifecycle system 105 to communicate over the network 104 with the application development pipeline 102-1, development tool 102-2, database 102-3, and a software repository 102-4 and illustratively comprises one or more conventional transceivers.

A secure development lifecycle system 105 may be implemented at least in part in the form of software that is stored in memory and executed by a processor, and may reside in any processing device. The secure development lifecycle system 105 may be a standalone plugin that may be included within a processing device.

It is to be understood that the particular set of elements shown in FIG. 1 for secure development lifecycle system 105 involving the application development pipeline 102-1, development tool 102-2, database 102-3, and a software repository 102-4 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the secure development lifecycle system 105 can be on and/or part of the same processing platform.

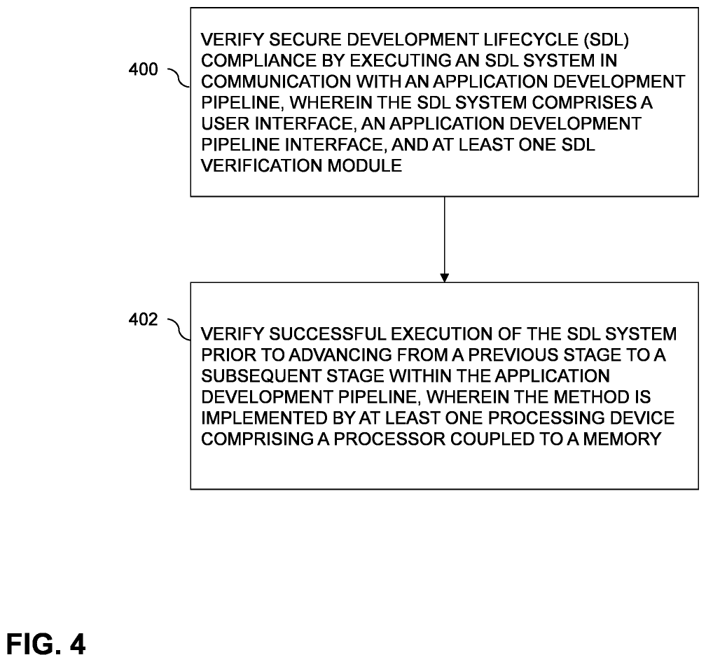

An exemplary process of secure development lifecycle system 105 in computer network 100 will be described in more detail with reference to, for example, the flow diagram of FIG. 4.

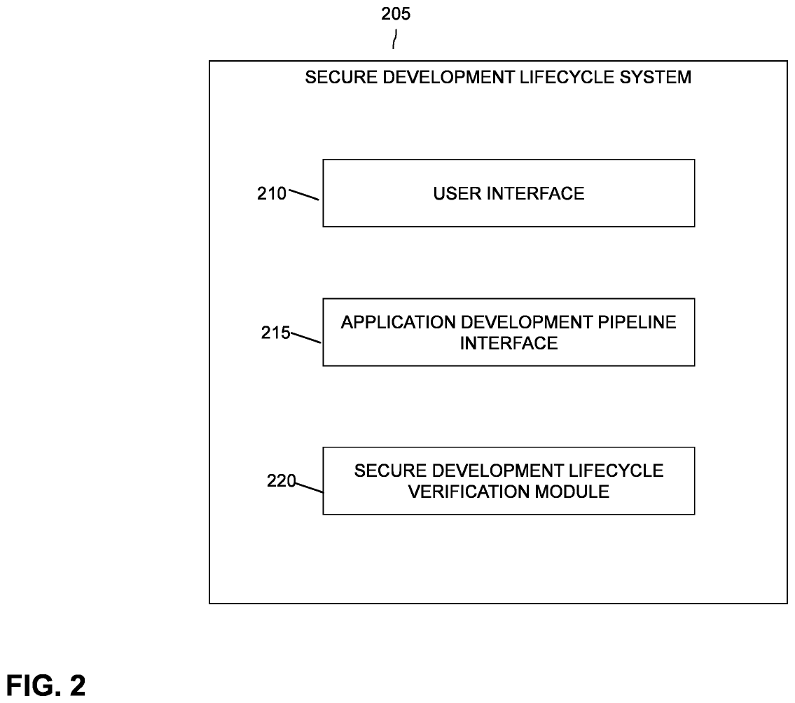

Referring now to FIG. 2, this figure shows an example of a secure development lifecycle system 105 in an illustrative embodiment. A user interface 210 allows a user to view a progression of the execution of the secure development lifecycle system 105. The application development pipeline interface 215 interfaces with an application development pipeline, such as, for example, a Jenkins pipeline. In an example embodiment, execution of a previous step in an application development pipeline may trigger execution of the secure development lifecycle system. In an example embodiment, the previous step may be, for example, a testing step of the application development pipeline. In an example embodiment, only if the secure development lifecycle system successfully passes, will the process advance to the next step of the application development pipeline process, for example, the staging or production step.

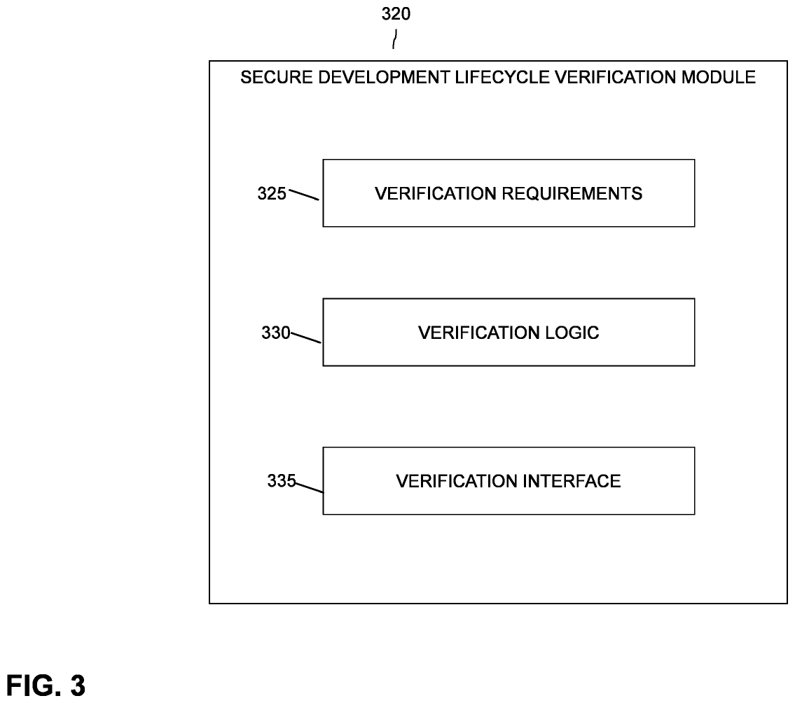

The secure development lifecycle system also comprises a secure development lifecycle verification module 220 that ensures policies associated with the security requirements of the software development lifecycle are verified so that a product and/or application will at least meet, if not surpass, the software development lifecycle's compliance level. The secure development lifecycle verification module 220 will be discussed in greater detail in FIG. 3.

Referring now to FIG. 3, this figure shows an example of a secure development lifecycle verification module 320 in an illustrative embodiment. The secure development lifecycle verification module 320 comprises verification requirements 325, verification logic 330, and a verification interface 335. The verification requirements 325 represent the SDL policy that needs to be verified was completed. For example, a company may have a security officer/champion who defines the polies and procedures for secure development lifecycle according to standards and protocols associated with the company and/or the industry. The policy may be, for example, a set of parameters that are used to verify controls associated with the software development lifecycle. An example policy may be that code is required to be reviewed by two people, and one of the reviewers is required to be senior to a person who performs the commit of the code. Another requirement may be, for example, that at least one of the approvers must be either equal or higher rank/experience than the code writer. Another requirement may be, for example, that the code writer may not be one of the required reviewers. The verification logic 330 is the logic that performs the verification to determine if each of the secure development lifecycle verification modules 330 have been successfully completed. Thus, the security officer/champion may define the policies and procedures for secure development lifecycle, and through the secure development lifecycle system 105, monitors implementation of the policies and procedures. The verification interface 335 is in communication with, for example, the application development pipeline 102-1, a development tool 102-2, a database 102-3 and/or a software repository 102-4. In an example embodiment, when the verification logic 330 in the secure development lifecycle verification module 320 is executed, the verification logic 330 executes verification requirements 325 defined in the secure development lifecycle verification module 320. For example, the verification logic 330 may log into, for example, a code repository, such as software repository 102-4. The verification logic verifies whether the code is reviewed, and if not, the secure development lifecycle verification module 320 reports a failure. If the code is reviewed, the verification logic 330 then verifies whether the code was reviewed by 2 or more people. Again, if not, the secure development lifecycle verification module 320 reports a failure. Otherwise, the verification logic 330 examines whether one of the code reviewers is the code writer. If yes, the secure development lifecycle verification module 320 reports a failure. Otherwise, the verification logic 330 verifies if at least one of the code reviewers has the necessary rank. If not, the secure development lifecycle verification module 320 reports a failure. Otherwise, the verification logic 330 has completed and the secure development lifecycle verification module 320 reports success of that secure development lifecycle verification module 320.

FIG. 4 is a flow diagram of a process for execution of the secure development lifecycle system 205 in an illustrative embodiment. It is to be understood that this particular process is only an example, and additional or alternative processes can be carried out in other embodiments.

At 400, secure development lifecycle (SDL) compliance is verified by executing a secure development lifecycle system 105 in communication with an application development pipeline 102-1, where the secure development lifecycle system 105 comprises a user interface 210, an application development pipeline interface 215, and at least one secure development lifecycle verification module 320. In an example embodiment, the secure development lifecycle verification module 320 comprises verification requirements 325, verification logic 330, and at least one verification interface 335, where the verification logic is executed via the verification interface.

In an example embodiment, the verification interface 335 is in communication with at least one development tool 102-2. For example, the development tool 102-2 may be an application that identifies open source software within the code base for which the secure development lifecycle system 105 is verifying compliance. The development tool 102-2 may be an open source software component management software that scans a code base for open source and 3^{rd} party software. In this example scenario, the verification requirements 325 may require that the code base cannot contain 3^{rd} party software or open source software vulnerabilities that are ranked higher than “Medium”. In an example embodiment, when the verification logic 330 executes, a code scan using the open source software component management software is invoked through verification interface 335 which is in communication with, and receives results from the open source software component management software. In an example embodiment, the open source software component management software is invoked using a representational state transfer (REST) API (i.e., an application programming interface that conforms to the constraints of REST architectural style, and allows for interaction with RESTful web services). If any vulnerabilities are found that have a severity rank higher than “Medium”, the secure development lifecycle verification module 320 reports back a failure to the secure development lifecycle system 105.

In an example embodiment, a verification requirement 325 may be that all the open source software component management software security issues found that are ranked “High” and/or “Critical” must be remediated prior to successful execution of the secure development lifecycle system 105.

In an example embodiment, the verification interface 335 is in communication with at least one software repository 102-4 or database 102-3. For example, the verification interface 335 may be a code repository connector that connects into a code repository, such as an open source software repository. In another example embodiment, the verification interface 335 may be a Lightweight Directory Access Protocol (LDAP) connector to interface with an LDAP server.

At 402, successful execution of the secure development lifecycle system 105 is verified prior to advancing from a previous stage to a subsequent stage within the application development pipeline. In an example embodiment the verification is implemented by at least one processing device comprising a processor coupled to a memory. In an example embodiment, a new step is added to the application development pipeline for the secure development lifecycle system 105. In an example embodiment, the previous stage is a testing stage of the application development pipeline, and the subsequent stage is a staging stage of the application development pipeline. In an example embodiment, completion of at least one stage in the application development pipeline 102-1 triggers execution of the secure development lifecycle system 105. For example, completion of the “test” step of the application development pipeline 102-1 may trigger execution of the secure development lifecycle system 105.

In an example embodiment, the secure development lifecycle verification module 320 may have one or more verification interfaces 335. For example, the verification interface 335 may have a code repository connector that connects into a code repository, such as an open source software repository, and may also have a Lightweight Directory Access Protocol (LDAP) connector to interface with an LDAP server.

In an example embodiment, successful execution of a second secure development lifecycle verification module 320 may be a verification requirement 325 of the secure development lifecycle verification module 320. In this fashion, the secure development lifecycle system 105 may be expanded by adding additional secure development lifecycle verification modules 320. There may be dependencies between the secure development lifecycle system 105 and the added secure development lifecycle verification modules 320. For example, the successful completion of the secure development lifecycle system 105 may be dependent on the successful completion of at least one of the added secure development lifecycle verification modules 320.

In an example embodiment, the secure development lifecycle system 105 monitors successful execution of the secure development lifecycle verification modules 320 in the secure development lifecycle system 105, and verifies successful completion of at least one secure development lifecycle verification module 320. In an example embodiment, if there is a failure of the secure development lifecycle verification module 320, the secure development lifecycle system 105 is notified, and an error that caused a failure of at least one secure development lifecycle verification modules 320 is identified.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly verify enforcement of secure development lifecycle compliance. These and other embodiments can effectively improve compliance with secure development lifecycle processes relative to conventional approaches. For example, embodiments disclosed herein continuously verify compliance of secure development lifecycle across many and various applications and products assuring that minimum compliance levels are maintained. Embodiments disclosed herein provide a system that is easily scaled and allows for verification of hierarchies of dependencies among the policies and procedures according to the requirement for secure development lifecycle compliance. Embodiments disclosed herein provide a system for collaboration among the security officer/champion, product security champion, architect, quality assurance and development & deployment teams to ensure secure development lifecycle compliance.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

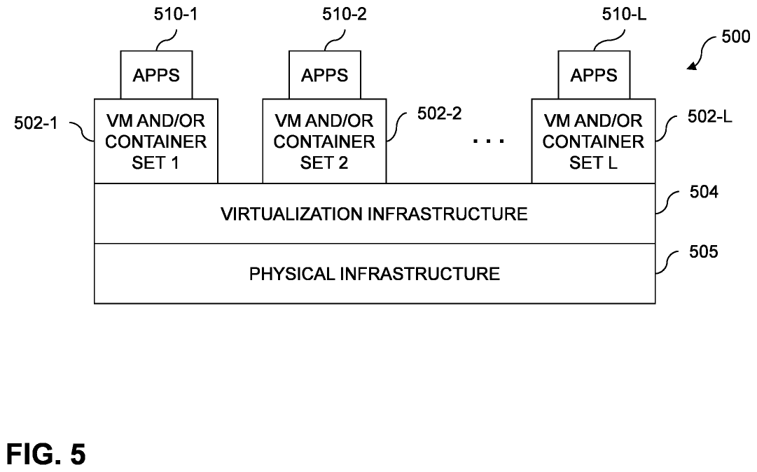

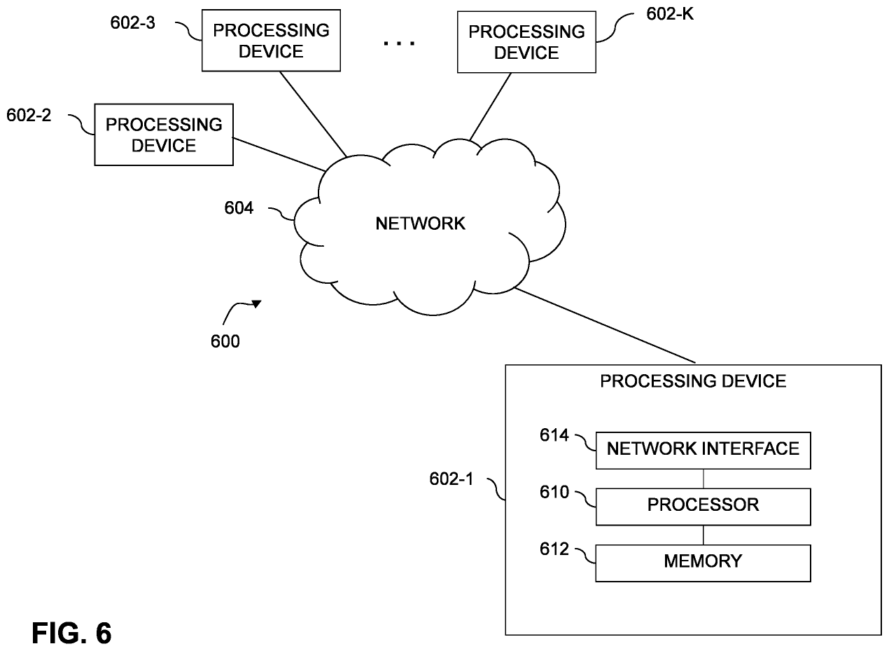

Illustrative embodiments of processing platforms will now be described in greater detail with reference to FIGS. 5 and 6. Although described in the context of the information processing system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, where the hypervisor platform has an associated virtual infrastructure management system. The underlying physical machines comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of the information processing system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a microcontroller, an application-specific integrated circuit (ASIC), a field-programmable gate array (FPGA) or other type of processing circuitry, as well as portions or combinations of such circuitry elements.

The memory 612 comprises random access memory (RAM), read-only memory (ROM) or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
verifying secure development lifecycle (SDL) compliance by executing an SDL system in communication with an application development pipeline, wherein the SDL system comprises a user interface, an application development pipeline interface, and at least one SDL verification module; and
verifying successful execution of the SDL system prior to advancing from a previous stage to a subsequent stage within the application development pipeline, wherein the method is implemented by at least one processing device comprising a processor coupled to a memory.

2. The method of claim 1 wherein the at least one SDL verification module comprises verification requirements, verification logic, and at least one verification interface, wherein the verification logic is executed via the verification interface.

3. The method of claim 1 wherein the at least one verification interface is in communication with at least one development tool.

4. The method of claim 1 wherein the at least one verification interface is in communication with at least one database.

5. The method of claim 1 wherein the at least one verification interface is in communication with at least one software repository.

6. The method of claim 1 further comprising:
monitoring successful execution of the at least one SDL verification module in the SDL system.

7. The method of claim 6 further comprising:
verifying successful completion of the at least one SDL verification module.

8. The method of claim 6 further comprising:
notifying the SDL system of failure of the at least one SDL verification module.

9. The method of claim 6 further comprising:
identifying an error that caused a failure of the at least one SDL verification module.

10. The method of claim 1 wherein completion of at least one stage in the application development pipeline triggers execution of the SDL system.

11. The method of claim 1 wherein the at least one verification interface is in communication with at least one second SDL verification module.

12. The method of claim 11 wherein successful execution of the at least one second SDL verification module is a verification requirement of the at least one SDL verification module.

13. The method of claim 1 wherein the previous stage is a testing stage of the application development pipeline, and the subsequent stage is a staging stage of the application development pipeline.

14. A system comprising:
at least one processing device comprising a processor coupled to a memory;
the at least one processing device being configured:
to verify secure development lifecycle (SDL) compliance by executing an SDL system in communication with an application development pipeline, wherein the SDL system comprises a user interface, an application development pipeline interface, and at least one SDL verification module; and
to verify successful execution of the SDL system prior to advancing from a previous stage to a subsequent stage within the application development pipeline, wherein the method is implemented by at least one processing device comprising a processor coupled to a memory.

15. The system of claim 14 wherein the at least one SDL verification module comprises verification requirements, verification logic, and at least one verification interface, wherein the verification logic is executed via the verification interface.

16. The system of claim 14 wherein the at least one verification interface is in communication with at least one development tool.

17. The system of claim 14 wherein the at least one verification interface is in communication with at least one database.

18. The system of claim 14 wherein the at least one verification interface is in communication with at least one software repository.

19. The system of claim 14 further configured to:
monitor successful execution of the at least one SDL verification module in the SDL system.

20. A computer program product comprising a non-transitory processor-readable storage medium having stored therein program code of one or more software programs, wherein the program code when executed by at least one processing device causes said at least one processing device:
to verify secure development lifecycle (SDL) compliance by executing an SDL system in communication with an application development pipeline, wherein the SDL system comprises a user interface, an application development pipeline interface, and at least one SDL verification module; and
to verify successful execution of the SDL system prior to advancing from a previous stage to a subsequent stage within the application development pipeline, wherein the method is implemented by at least one processing device comprising a processor coupled to a memory.
